(19) United States
(12) Patent Application Publication
(10) Pub. No.: US 2019/0355357 A1
(43) Pub. Date: Nov. 21, 2019

(54) DETERMINING DEVICE, ELECTRONIC APPARATUS, RESPONSE SYSTEM, METHOD OF CONTROLLING DETERMINING DEVICE, AND STORAGE MEDIUM

(71) Applicant: SHARP KABUSHIKI KAISHA, Osaka (JP)

(72) Inventor: SHIGEFUMI URATA, Sakai City (JP)

(21) Appl. No.: 16/416,203

(22) Filed: May 18, 2019

(30) Foreign Application Priority Data
May 18, 2018 (JP) 2018-096494

(51) Int. Cl. G10L 15/22; G10L 15/08; G10L 15/05

(52) U.S. Cl. CPC G10L 15/22; G10L 15/08; G10L 2015/088; G10L 2015/223; G10L 2015/225; G10L 15/05

(57) ABSTRACT

Undesired responses that would result from the audio from a TV set, radio receiver, or the like are prevented. A server control section includes: an information acquiring section configured to acquire a recognized information item; and a response determining section configured to determine whether or not to cause an electronic apparatus to carry out a response that corresponds to the recognized information item, the response determining section being configured to determine not to cause the electronic apparatus to carry out the response that corresponds to the recognized information item if a second recognized information item that is identical in content to the recognized information item is acquired before acquisition of the recognized information item or within a prescribed period of time after the acquisition of the recognized information item.

This Nonprovisional application claims priority under 35 U.S.C. § 119 on Patent Application No. 2018-096494 filed in Japan on May 18, 2018, the entire contents of which are hereby incorporated by reference.

### TECHNICAL FIELD

One or more embodiments of the present invention relate to a determining device and the like each of which determines whether or not to prepare a message that is to be outputted from an electronic apparatus.

### BACKGROUND ART

Electronic apparatuses that carry out speech recognition of an acquired user's speech and output a response message corresponding to the result of the speech recognition are known. In regard to such electronic apparatuses, various techniques have been developed to carry out the speech recognition and the output of the response message each at the right time.

For example, Patent Literature 1 discloses a speech recognition apparatus that starts speech recognition upon receipt of a particular word or phrase as a trigger. The particular word or phrase recognized by the speech recognition apparatus is a word or phrase used in limited situations, such as a word or phrase that is not often used in ordinary conversation, a word or phrase that is not in the native language of a speaker, or a word or phrase that has the meaning of a voice activation command. This prevents speech recognition that is not intended by the speaker from being started upon receipt of ordinary conversation as a trigger.

### CITATION LIST

### Patent Literature

### [Patent Literature 1]

Japanese Patent Application Publication, Tokukai No. 2004-301875

### SUMMARY OF INVENTION

### Technical Problem

However, according to the technique disclosed in Patent Literature 1, if audio from a TV set, radio receiver, or the like contains the aforementioned particular word or phrase, the speech recognition apparatus may start speech recognition at a time not intended by the speaker.

One example is as follows. It is likely that a TV set and radio receiver output conversing voices in various situations. Therefore, even if the aforementioned particular word or phrase is merely set to a word or phrase that is not often used in ordinary conversation, this is not sufficient to completely prevent misrecognition. Furthermore, for example, there is a sufficient likelihood that the audio from a TV set or radio receiver may contain the word or phrase that is not in the native language of the speaker. Therefore, even if the particular word or phrase is set to a word or phrase in a language other than the native language of the speaker, this is still not sufficient to completely prevent misrecognition.

In addition, in cases of an electronic apparatus that is designed to output a response message, the electronic apparatus outputs a response message based on the result of speech recognition that was started unintentionally. In other words, the electronic apparatus carries out an undesired response.

One aspect of the present discloser was made in view of the above issues, and an object thereof is to provide a determining device and the like which are capable of preventing undesired responses that would result from the audio from a TV set, radio receiver, or the like.

### Solution to Problem

In order to attain the above object, a determining device in accordance with one aspect of the present invention is a determining device configured to determine whether or not to cause an electronic apparatus that includes a speech input device to respond, the determining device including an information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and a response determining section configured to determine whether or not to cause the electronic apparatus to carry out a response that corresponds to the recognized information item, the response determining section being configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

### Advantageous Effects of Invention

According to one aspect of the present invention, it is possible to prevent undesired responses that would result from audio from a TV set, radio receiver, or the like.

### BRIEF DESCRIPTION OF DRAWINGS

FIG. 1 is a block diagram illustrating configurations of main parts of conversational robots and a cloud server which are included in a response system in accordance with Embodiment 1 of the present invention.

FIG. 2 illustrates one example of a data structure of a determination database that is stored in a storage section of the cloud server.

FIG. 3 illustrates an outline of actions carried out by the conversational robots.

FIG. 4 is a flowchart of a flow of a response necessity determining process carried out by the response system.

FIG. 5 is a block diagram illustrating configurations of main parts of conversational robots and a cloud server which are included in a response system in accordance with Embodiment 2 of the present invention.

FIG. 6 is a block diagram illustrating configurations of main parts of conversational robots included in a response system in accordance with Embodiment 3 of the present invention.

FIG. 7 is a flowchart of a flow of a response necessity determining process carried out by the response system.

FIG. 8 is a block diagram illustrating configurations of main parts of conversational robots and a cloud server which are included in a response system in accordance with Embodiment 4 of the present invention.

FIG. 9 illustrates one example of a data structure of a determination database stored in a storage section of the cloud server.

FIG. 10 is a flowchart of a flow of a response necessity determining process carried out by the response system.

### DESCRIPTION OF EMBODIMENTS

The present disclosure relates to a response system that determines, based on a result of speech recognition of an input speech and a point in time of the input or of the speech recognition, whether or not to carry out a response to the input speech. The following description will discuss example embodiments of the present disclosure with reference to drawings.

### Embodiment 1

<<Configuration of Main Parts of Devices>>

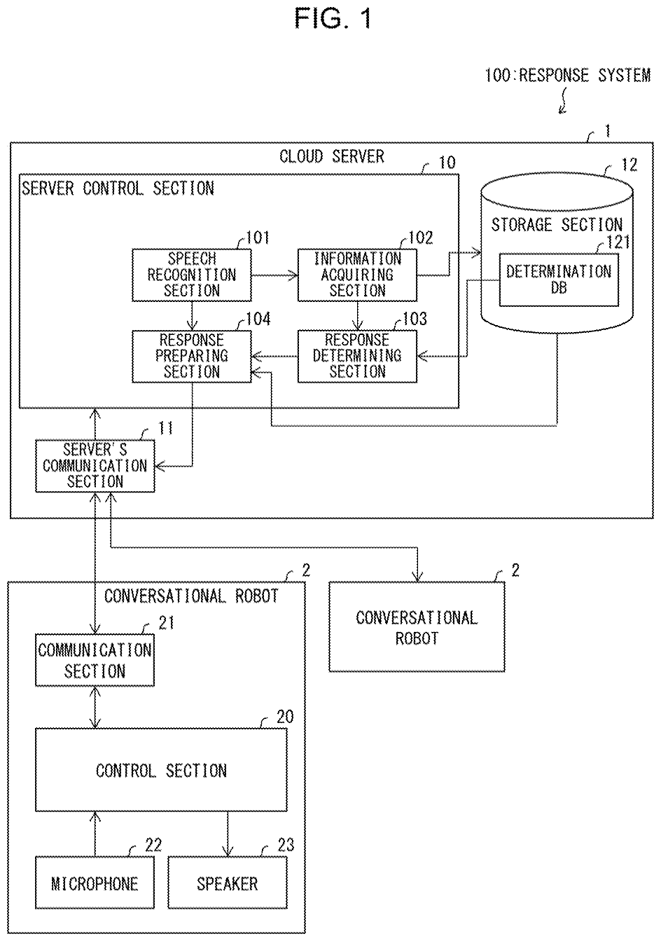

The following description will discuss Embodiment 1 of the present disclosure with reference to FIGS. 1 to 4. FIG. 1 is a block diagram illustrating configurations of main parts of conversational robots 2 and a cloud server 1 which are included in a response system 100 in accordance with Embodiment 1. The response system 100 includes at least one cloud server 1 and a plurality of conversational robots (electronic apparatuses) 2. Although the number of conversational robots 2 in the example shown in FIG. 1 is two, the number of conversational robots 2 is not particularly limited, provided that the number is two or more. The two conversational robots 2 in FIG. 1 are equal in configuration to each other; therefore, one of the conversational robots 2 in FIG. 1 is illustrated in a simplified manner.

(Configuration of main parts of conversational robots 2) Each conversational robot 2 is a robot that converses with a user by responding to a speech of the user. The conversational robot 2 includes, as illustrated in FIG. 1, a control section (determining device) 20, a communication section 21, a microphone (speech input device) 22, and a speaker (responding section) 23.

The communication section 21 serves to communicate with the cloud server 1. The microphone 22 serves to input, into the control section 20, a sound around the conversational robot 2 as an input speech.

The control section 20 serves to carry out an overall control of the conversational robot 2. The control section 20 is configured to, upon receipt of a speech inputted via the microphone 22, acquire a time at which the speech was inputted (speech input time). The speech input time may be determined by any method, and may be determined based on, for example, an internal clock of the control section 20 or the like. The control section 20 sends the acquired speech to the cloud server 1 via the communication section 21. The speech, when sent from the control section 20 to the cloud server 1, is assigned the speech input time and identification information that identifies the conversational robot 2 in which the control section 20 is included (such identification information is referred to as robot identification information). The control section 20 also serves to cause the speaker 23 to output a response message (described later) that is received from the cloud server 1 via the communication section 21. The speaker 23 outputs the response message in a sound form in accordance with control by the control section 20.

Embodiment 1 is based on the assumption that the conversational robot 2 outputs a response in the form of a voice message; however, the conversational robot 2 may carry out a response to a user's speech by some means other than the voice message. For example, the conversational robot 2 may include a display device in addition to or instead of the speaker 23 and may cause the display device to display a message. Additionally or alternatively, the conversational robot 2 may include a movable part and a motor and may show a response using a gesture. Additionally or alternatively, the conversational robot 2 may include a lamp comprised of a light emitting diode (LED) or the like at a position viewable by the user and may show a response using blinking light.

(Configuration of Main Parts of Cloud Server 1)

The cloud server 1 determines whether or not to cause each conversational robot 2 to carry out a response. The cloud server 1 collects speeches from the conversational robots 2, carries out speech recognition of each of the speeches, and determines, based on the result of the speech recognition and the point in time of the speech recognition, whether or not to cause each conversational robot 2 to carry out a response. Embodiment 1 is based on the assumption that the response system 100 employs, as illustrated in FIG. 1, the cloud server 1 using a cloud network; however, the response system 100 may employ, instead of the cloud server 1, one or more servers that make a wired or wireless connection to the conversational robots 2. The same applies to the subsequent embodiments.

The cloud server 1 includes a server control section (determining device) 10, a server's communication section 11, and a storage section 12, as illustrated in FIG. 1. The server's communication section 11 serves to communicate with the conversational robots 2. The storage section 12 stores various kinds of data for use in the cloud server 1.

Specifically, the storage section 12 at least stores a determination database 121 (a collection of data for use in determination, hereinafter referred to as determination DB). The storage section 12 also stores data for use in preparation of a response message (e.g., forms or templates for response messages). A data structure of the determination DB 121 will be described later in detail.

The server control section 10 carries out an overall control of the cloud server 1. The server control section 10 includes a speech recognition section 101, an information acquiring section (recognized information storing section) 102, a response determining section (determination result sending section) 103, and a response preparing section 104. The server control section 10 receives speeches and their associated speech input times and robot identification information items from the conversational robots 2 via the server's communication section 11. Since the number of conversational robots 2 is two as illustrated in FIG. 1, the server control section 10 receives a speech, a speech input time, and robot identification information from each of the conversational robots 2. Then, the server control section 10 carries out the following processes on each of the speeches.

The speech recognition section 101 carries out speech recognition of the speeches received from the conversational robots 2. A method of the speech recognition is not limited to a particular kind. Embodiment 1 is based on the assumption that, by the speech recognition, words and phrases contained in a speech are converted into a character string. The speech recognition section 101 sends, to the response preparing section 104, the result of the speech recognition (hereinafter referred to as “recognition result” for short) that has associated therewith the robot identification information indicative of the conversational robot 2 from which the speech subjected to the speech recognition has been received.

The speech recognition section 101, after carrying out the speech recognition, prepares a recognized information item in which the recognition result and the speech input time are associated with each other. The speech recognition section 101 sends the recognized information item to the information acquiring section 102.

The information acquiring section 102 updates the determination DB 121 of the storage section 12 based on the recognized information item received from the speech recognition section 101. Here, the information acquiring section 102 updates the determination DB 121 in a way that depends on whether or not the determination DB 121 contains a recognized information item indicative of a recognition result and a speech input time that are identical to those of the received recognized information item. The following description discusses the details of a data structure of the determination DB 121 and the ways of updating of the determination DB 121 by the information acquiring section 102.

(Determination DB)

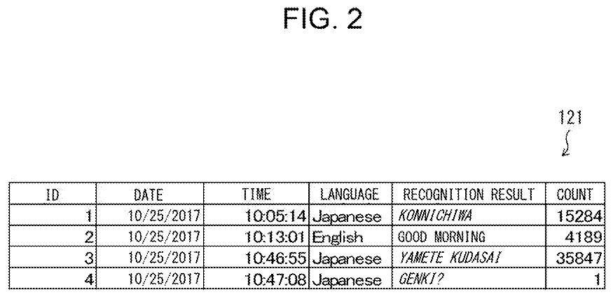

FIG. 2 illustrates one example of the data structure of the determination DB 121. The determination DB 121 is a collection of recognized information items, and is referenced to determine whether or not to prepare a response message. The determination DB 121 at least includes; data indicative of a recognition result; and data indicative of a speech input time.

In the example shown in FIG. 2, the determination DB 121 includes an “ID” column, a “DATE” column, a “TIME” column, a “LANGUAGE” column, a “RECOGNITION RESULT” column, and a “COUNT” column. Each record of FIG. 2 represents one recognized information item. The pieces of data stored in the “DATE” column, “TIME” column, “LANGUAGE” column, and “RECOGNITION RESULT” column are those which are contained in a recognized information item prepared by the speech recognition section 101. Note that the “LANGUAGE” column is not essential, and that the “DATE” column and “TIME” column may be integral with each other.

In the “ID” column, an identification code that uniquely identifies a recognized information item is stored. In the “DATE” column and “TIME” column, the month/date/year included in the speech input time and the time included in the speech input time are stored, respectively. In the “LANGUAGE” column, the type of the recognition result (the type is indicative of one, of prescribed languages, to which the recognition result belongs) is stored. The type may be determined when the speech recognition section 101 prepares the recognized information item or may be determined by the response determining section 103 based on the character string of the recognition result. In the “RECOGNITION RESULT” column, the character string of the recognition result is stored. In the “COUNT” column, the number of times the same recognized information item has been acquired is stored.

The information acquiring section 102, after acquiring the recognized information item, searches the determination DB 121 for a record which indicates a recognition result and speech input time that are identical to those of the received recognized information item. If no such records are found, the information acquiring section 102 adds a record representing the received recognized information item to the determination DB 121. In the “ID” column of the added record, a new identification code is stored. In the “COUNT” column of the added record, the number of times such a record has been acquired, that is, the number “1”, is stored.

It should be noted that the term “identical” or “same” used in Embodiment 1 refers to either exact matching or matching within a predetermined buffer (that is, substantially identical or partially identical). For specific example, the following arrangement may be employed: if the percentage of matching between character strings of two recognition results is equal to or greater than a predetermined threshold, these recognition results are determined as “identical recognition results”. Alternatively, the following arrangement may be employed: two speech input times are compared to each other and, if the difference between the two is within a predetermined time range, the two are determined as “identical times”. The same applies to the following embodiments.

On the contrary, if a record which indicates a recognition result and speech input time that are identical to those of the recognized information item received by the information acquiring section 102 is found, the information acquiring section 102 increments the count stored in the “COUNT” column of the found record. For example, assuming that the recognized information item received by the information acquiring section 102 is indicative of the recognition result and speech input time which are identical to those of the recognized information item with an ID of 2, the information acquiring section 102 increments the count “4189”, which is indicative of the number of times the record with an ID of 2 has been acquired, by 1 to “4190”. The information acquiring section 102, after the update of the determination DB 121 completes, sends the recognized information item acquired from the speech recognition section 101 to the response determining section 103.

Each record in the determination DB 121 may be automatically deleted after a certain period of time (e.g., 10 seconds) has passed. This makes it possible to prevent the number of records in the determination DB 121 from increasing with time, and thus possible to shorten the time from when a speech is inputted to when a response message is outputted (i.e., the time taken for conversational robot 2 to respond).

The response determining section 103 determines whether or not to prepare a response message (that is, whether or not to cause a conversational robot 2 to carry out a response), based on the recognized information item acquired from the information acquiring section 102. Specifically, the response determining section 103 determines to prepare a response message if another recognized information item (referred to as a second recognized information item) that is identical in content (at least in recognized result and speech input time) to the acquired recognized information item is not present in the determination DB 121 before the acquisition of the acquired recognized information item or within a prescribed period of time after the acquisition of the acquired recognized information item. For example, the response determining section 103 may determine that the second recognized information item is not present in the determination DB 121 if the count of the record that is identical in content to the acquired recognized information item is “1”. On the contrary, the response determining section 103 determines not to prepare a response message if such a second recognized information item is present in the determination DB 121 before the acquisition of the acquired recognized information item or within a prescribed period of time after the acquisition of the acquired recognized information item.

Note here that the response determining section 103 carries out the determination at a prescribed point in time after acquiring the recognized information item from the information acquiring section 102. For example, the response determining section 103 waits a prescribed period of time (e.g., about 1 second) after the receipt of the recognized information item, and then carries out the determination.

With this arrangement, the response determining section 103 is capable of determining not to prepare a response message that corresponds to the recognized information item not only in cases where the second recognized information item has already been acquired (and reflected to the update of the determination DB 121) before the acquisition of the recognized information item but also in cases where the second recognized information item is acquired by the information acquiring section 102 within the prescribed period of time after the acquisition of the recognized information item.

For example, in regard to sounds of TV shows or the like, the same sounds are outputted (from different television sets) at different places at the same time. In such cases, a plurality of conversational robots 2 acquire the sounds substantially concurrently and send them to the cloud server 1; however, some time lag may occur between the conversational robots 2. When the response determining section 103 is configured to carry out the determination after a prescribed period of time after the update of the determination DB 121 by the information acquiring section 102, it is possible for the response determining section 103 to carry out the determination with accuracy even in cases where such a time lag occurs. Instead of delaying the determination by the response determining section 103, the sending of the recognized information item from the information acquiring section 102 to the response determining section 103 may be delayed. The response determining section 103 sends the result of the determination to the response preparing section 104.

Note that the response determining section 103 may be configured as below: if a record indicative of a recognition result and speech input time that are identical to those of the acquired recognized information item is present in the determination DB 121 and the count of that record is less than a prescribed value, the response determining section 103 determines to prepare a response, whereas, if the count of that record is equal to or greater than the prescribed value, the response determining section 103 determines not to prepare a response.

Alternatively, the response determining section 103 may be configured as below: the response determining section 103 waits (i.e., not carry out the determination) a prescribed period of time (e.g., 1 second) after the update of the determination DB 121 by the information acquiring section 102; and, if the “COUNT” of the record of the updated recognized information item (that is, the record that corresponds to the recognized information item that the response determining section 103 acquired) in the determination DB 121 does not increase while the response determining section 103 is waiting, the response determining section 103 determines to prepare a response, whereas, if the “COUNT” increases while the response determining section 103 is waiting, the response determining section 103 determines not to prepare a response.

The response preparing section 104 prepares a response message that corresponds to the recognition result, and sends the prepared response message to a robot indicated by the robot identification information associated with that recognition result. The response preparing section 104, after receiving from the response determining section 103 the result of determination indicating that a response message is to be prepared, refers to a response message template or the like in the storage section 12 to thereby prepare a response message that corresponds to the recognition result. The response preparing section 104 sends the prepared response message to a corresponding conversational robot 2 via the server's communication section 11. In so doing, the response preparing section 104 sends the response message to a conversational robot 2 that is indicated by the robot identification information associated with the recognition result. This makes it possible to send, back to one conversational robot 2, a response message that corresponds to the speech acquired at that conversational robot 2.

<<Outline of Actions Carried Out by Conversational Robot 2>>

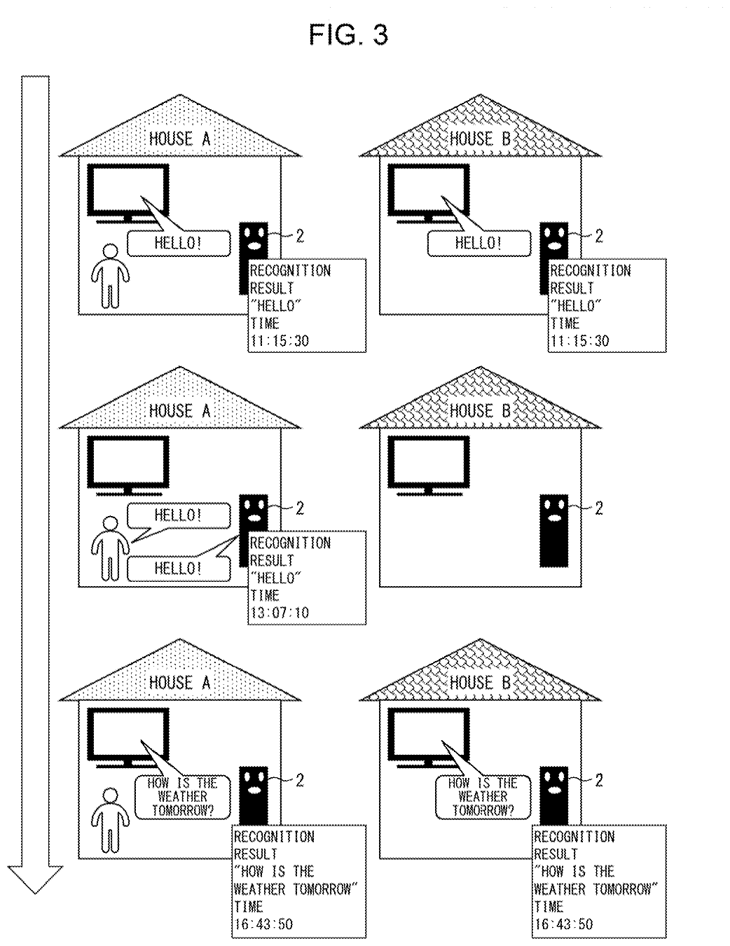

Next, an outline of actions carried out by the response system 100 in accordance with Embodiment 1 is described. FIG. 3 illustrates an outline of actions carried out by conversational robots included in the response system 100. The hollow arrow in FIG. 3 indicates a flow of time. In the example shown in FIG. 3, conversational robots 2 are located at a house A and a house B, respectively. Note that the cloud server 1 is not illustrated in the example shown in FIG. 3, assuming that the cloud server 1 is located somewhere away from the houses.

Assume that, as illustrated in FIG. 3, a television set outputs the speech “HELLO” at the time 11:15:30. In this case, the conversational robot 2 at each house acquires the speech “HELLO” and sends it to the cloud server 1. The cloud server 1 carries out speech recognition of the speech from each conversational robot 2. In the example shown in FIG. 3, the speeches of identical content are sent from the two conversational robots 2 at the houses A and B substantially concurrently to the cloud server 1, and therefore recognized information items with identical recognition results and speech input times are obtained. The information acquiring section 102 updates the determination DB 121 based on these recognized information items.

After a prescribed period of time after that, the response determining section 103 determines whether or not to carry out a response, in regard to each of the recognized information items attributed to the respective conversational robots 2. As described earlier, since a record with a recognition result and speech input time that are identical to those of the acquired recognized information items is present in the determination DB 121, the response determining section 103 determines not to prepare a response message in regard to each of the recognized information items. Therefore, the response preparing section 104 does not prepare a response message, and thus both the conversational robots 2 at the houses A and B do not output any speech.

On the contrary, assume that a user says “HELLO” to the conversational robot 2 at the house A at the time 13:07:10. In this case, a speech is sent to the cloud server 1 only from the conversational robot 2 of the house A. In this case, a record with a recognition result and speech input time that are identical to those of the prepared recognized information item is not present in the determination DB 121 before the acquisition of the prepared recognized information item or within a prescribed period of time after the acquisition of the prepared recognized information item. Therefore, the response determining section 103 determines to prepare a response message, and the response preparing section 104 sends, to the conversational robot 2, a response message “HELLO” that corresponds to the recognition result indicative of “HELLO”. Then, the conversational robot 2 outputs a speech “HELLO” via the speaker 23.

Furthermore, assume that the television sets output a speech “HOW IS THE WEATHER TOMORROW” at the time 16:43:50. In this case, as with the case of the time 11:15:30, the speeches of identical content are sent from the two conversational robots 2 at the houses A and B substantially concurrently to the cloud server 1, and therefore recognized information items with identical recognition results and speech input times are obtained. Therefore, the response determining section 103 determines not to prepare a response message in regard to each of the recognized information items, and the response preparing section 104 does not prepare a response message. Thus, both the conversational robots 2 at the houses A and B do not output any speech.

<<Flow of Process>>

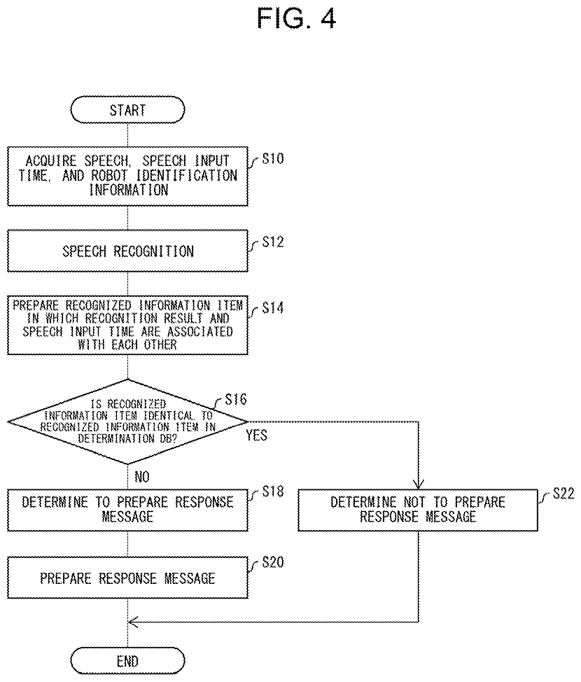

Lastly, a flow of a process of determining whether or not to prepare a response message (such a process is referred to as a response necessity determining process) carried out by the response system 100 is described with reference to FIG. 4. FIG. 4 is a flowchart of a flow of the response necessity determining process carried out by the response system 100. Note that the example shown in FIG. 4 shows a flow of the response necessity determining process carried out in regard to a certain input speech (in regard to a single input).

The control section 20 of a conversational robot 2, upon receipt of an ambient sound (speech) via the microphone 22, acquires a speech input time. The control section 20 sends, to the cloud server 1, the input speech that has the speech input time and robot identification information associated therewith. The server control section 10 of the cloud server 1 acquires the speech, the speech input time, and the robot identification information (S10). The speech recognition section 101 carries out speech recognition of the acquired speech (S12), and prepares a recognized information item in which the recognition result and the speech input time are associated with each other (S14). The speech recognition section 101 sends the recognized information item to the information acquiring section 102.

Upon receipt of the recognized information item (information acquiring step), the information acquiring section 102 updates the determination DB 121 and sends the recognized information item to the response determining section 103. Upon receipt of the recognized information item, the response determining section 103 determines, after a prescribed period of time, whether or not the received recognized information item is identical to any of recognized information item(s) (second recognized information item(s)) in the determination DB 121 (S16, response determining step). If it is determined that the received recognized information item is identical to any of the recognized information item(s) in the determination DB 121 (YES in S16), the response determining section 103 determines not to prepare a response message (S22). On the contrary, if it is determined that the received recognized information item is not identical to any of the recognized information item(s) in the determination DB 121 (NO in S16), the response determining section 103 determines to prepare a response message (S18), and the response preparing section 104 prepares a response message that corresponds to the recognition result (S20). The response preparing section 104 sends the prepared response message to the conversational robot 2 indicated by the robot identification information, and the conversational robot 2 outputs the response message via the speaker 23.

According to the above process, in cases where the recognition results of identical content are acquired at the same time, the response determining section 103 of the cloud server 1 determines, in regard to each of the recognized information items indicative of those recognition results, not to prepare a response message which corresponds to that recognized information item (that is, the response determining section 103 determines not to cause the conversational robot 2 to carry out a response).

In regard to audio from a TV set, radio receiver, or the like, the same sounds are outputted (from different television sets or radio receivers) at different places at the same time. It is inferred that, in such cases, a plurality of conversational robots 2 acquire the sounds of identical content substantially concurrently and send them to the cloud server 1. According to the above arrangement, it is determined that a response be not made in such cases, and therefore possible to prevent undesired responses that would result from the audio from a TV set, radio receiver, or the like.

The speech recognition section 101 of the cloud server in accordance with Embodiment 1 may acquire a recognition time when carrying out speech recognition. The recognition time is the time at which the speech recognition is carried out. The recognition time is obtained based on, for example, a time determining section (not illustrated) of the cloud server 1, a control clock of the server control section 10, or the like. The recognized information item prepared by the speech recognition section 101 may be an information item in which the speech is associated with the recognition time, instead of the information item in which the speech is associated with the speech input time. The same applies to the subsequent embodiments.

In this case, in the “DATE” column and “TIME” column of the determination DB 121, the month/date/year included in the recognition time and the time included in the recognition time are stored, respectively. In this case, the control section 20 of the conversational robot 2 may send, to the cloud server 1, the speech and the robot identification information associated with each other, without acquiring the speech input time.

### Embodiment 2

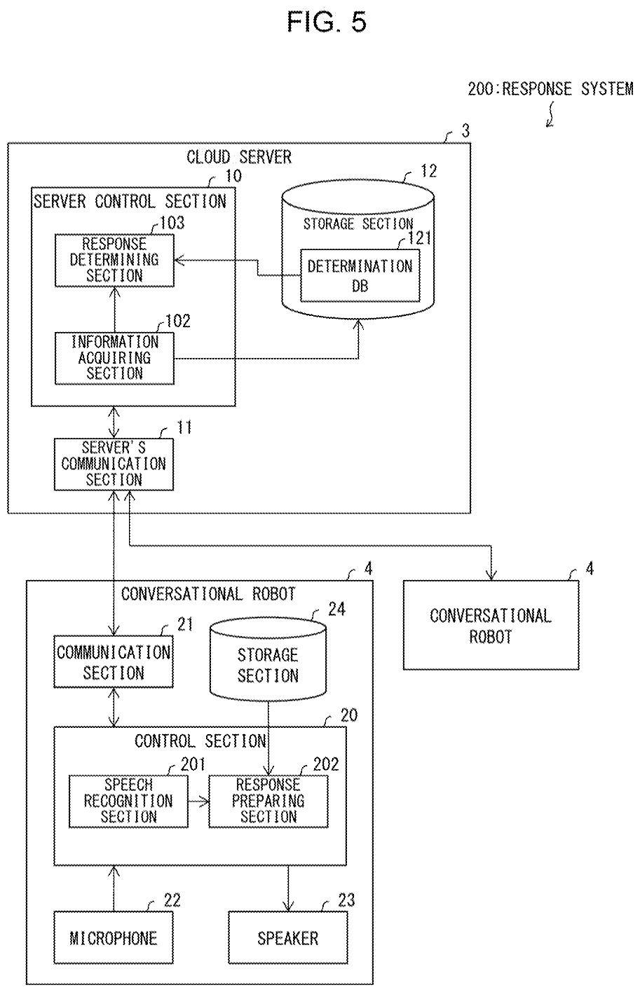

In a response system in accordance with the present disclosure, the speech recognition and the preparation of a response message may be carried out by a conversational robot. The following description will discuss Embodiment 2 of the present disclosure with reference to FIG. 5. For convenience of description, members having functions identical to those described in Embodiment 1 are assigned identical referential numerals, and their descriptions are omitted here. The same applies to the following embodiments.

FIG. 5 is a block diagram illustrating configurations of main parts of conversational robots 4 and a cloud server 3 which are included in a response system 200 in accordance with Embodiment 2. The cloud server 3 is different from the cloud server 1 in that the cloud server 3 does not include the speech recognition section 101 or the response preparing section 104. The conversational robots 4 are different from the conversational robots 2 in that the conversational robots 4 each include a storage section 24, a speech recognition section 201, and a response preparing section 202.

The storage section 24 stores data for use in preparation of a response message (e.g., forms or templates for response messages). The speech recognition section 201 has functions similar to those of the speech recognition section 101 described in Embodiment 1. The response preparing section 202 has functions similar to those of the response preparing section 104 described in Embodiment 1. According to the response system 200 in accordance with Embodiment 2, the control section 20 of each conversational robot 4 is configured to, upon receipt of a speech via a microphone 22, acquire a speech input time and carry out speech recognition through use of the speech recognition section 201. The speech recognition section 201 prepares a recognized information item in which the result of the speech recognition and the speech input time are associated with each other. The speech recognition section 201 sends, to the cloud server 3, the recognized information item having robot identification information associated therewith. The speech recognition section 201 also sends the recognized information item to the response preparing section 202.

The information acquiring section 102 of the cloud server 3 acquires the recognized information item from the conversational robot 4, and carries out processes similar to those described in Embodiment 1. The response determining section 103 also carries out a determination similar to that described in Embodiment 1, and sends the result of the determination to the conversational robot 4 indicated by the robot identification information. The response preparing section 202 of the conversational robot 4, upon receipt of the result of determination indicating that a response message is to be prepared, refers to a response message template or the like stored in the storage section 24 to thereby prepare a response message. The control section 20 causes the speaker 23 to output the prepared response message.

In cases where a user and a conversational robot 4 are having a real-time conversation, it is important to quickly determine whether or not to carry out a response and cause the conversational robot 4 to output a response in a timely manner. According to the aforementioned processes, the cloud server 3 of the response system 200 does not carry out speech recognition and does not prepare a response message, and only carries out a determination of whether or not to carry out a response. This makes it possible to reduce the load on the cloud server 3 that is required to carry out processes in regard to a plurality of conversational robots 4. Furthermore, according to the aforementioned processes, the cloud server 3 needs only send, to a corresponding conversational robot 4, only the result of determination of whether or not to carry out a response. As such, it is possible to reduce the volume of transmitted data and to thereby reduce the load related to communications, as compared to when the cloud server 3 determines how to respond and sends, to the conversational robot 4, information indicative of how to respond. Thus, the cloud server 3 in accordance with Embodiment 2 makes it possible to carry out processes more quickly.

For example, the processing speed, which is related to the determination of whether or not to carry out a response, at the cloud server 3 also becomes quicker. This makes it possible for the conversational robots 4 to output a response message more quickly.

### Embodiment 3

In a response system in accordance with the present disclosure, conversational robots may exchange recognized information items with each other not via a cloud server. Each of the conversational robots may be configured to, if a recognized information item received from another (or the other) conversational robot (such a recognized information item is referred to as another recognized information item) is identical to a recognized information item prepared by itself, determine not to prepare a response message.

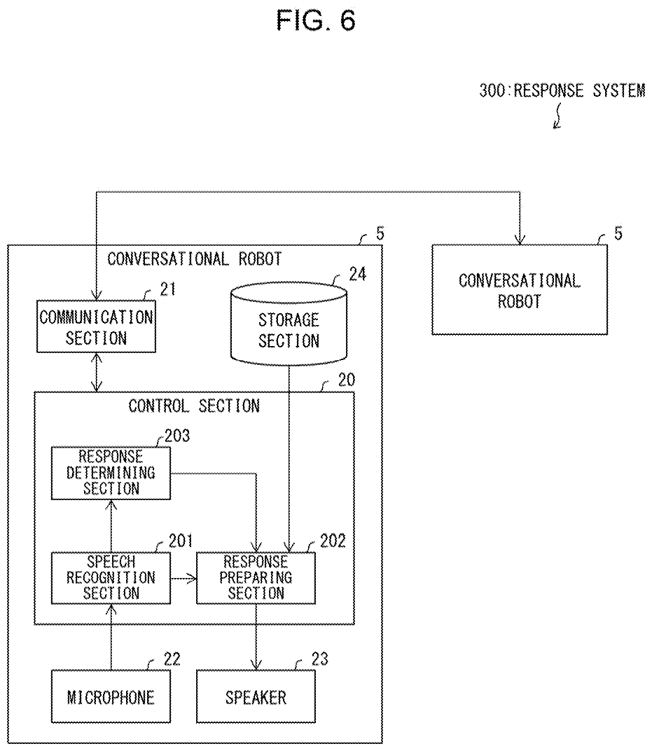

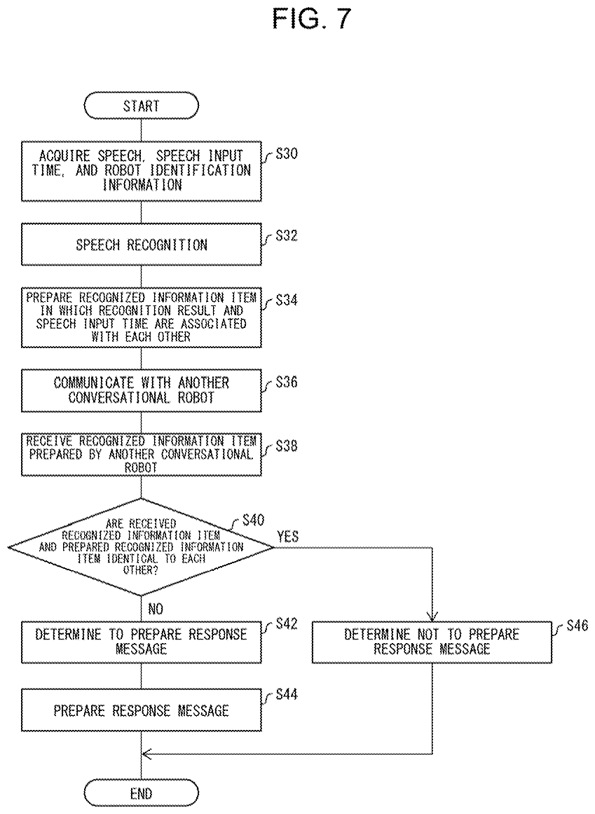

The following description will discuss Embodiment 3 of the present disclosure with reference to FIGS. 6 and 7. FIG. 6 is a block diagram illustrating configurations of main parts of conversational robots 5 included in a response system 300 in accordance with Embodiment 3. As illustrated in FIG. 6, the cloud server 1 may be omitted in the response system 300. The conversational robots 5 each include a response determining section 203 in addition to the features of the conversational robots 4.

FIG. 7 is a flowchart of a flow of a response necessity determining process carried out by the response system 300. The example shown in FIG. 7 also shows a flow of a response necessity determining process carried out in regard to a certain input speech (in regard to a single input), similarly to FIG. 4.

One conversational robot 5 acquires an ambient sound (speech) via the microphone 22 (S30), and carries out speech recognition (S32) and prepares a recognized information item (S34) through use of the speech recognition section 201. The one conversational robot 5 communicates with another conversational robot 5 (or each of the other conversational robots 5) (S36), and sends the prepared recognized information item to the another conversational robot 5 (or to each of the other conversational robots 5). The one conversational robot 5 also receives, from the another conversational robot 5 (or from each of the other conversational robots 5), a recognized information item prepared by the another conversational robot 5 (or by each of the other conversational robots 5) (S38).

The response determining section 203 of the control section 20 determines whether or not the received recognized information item (another recognized information item) is identical to the prepared recognized information item (S40). If it is determined that the received recognized information item is identical to the prepared recognized information (YES in S40), the response determining section 203 determines not to prepare a response message (S46). On the contrary, if it is determined that the received recognized information item is not identical to the prepared recognized information item (NO in S40), the response determining section 203 determines to prepare a response message (S42), and the response preparing section 202 prepares a response message that corresponds to the recognition result (S44). The control section 20 causes the speaker 23 to output the prepared response message.

According to the above processes, the conversational robots 5 are capable of determining whether recognition results of identical content were acquired at the same time by exchanging each other's recognized information items to check whether the information items match each other, even without use of a server such as the cloud server 1 or 3 described in other embodiments. As such, it is possible, only with the conversational robots 5, to prevent misrecognitions that would result from the audio from a TV set or the like, without having to construct a large-scale system or network that includes the cloud server 1 or 3.

### Embodiment 4

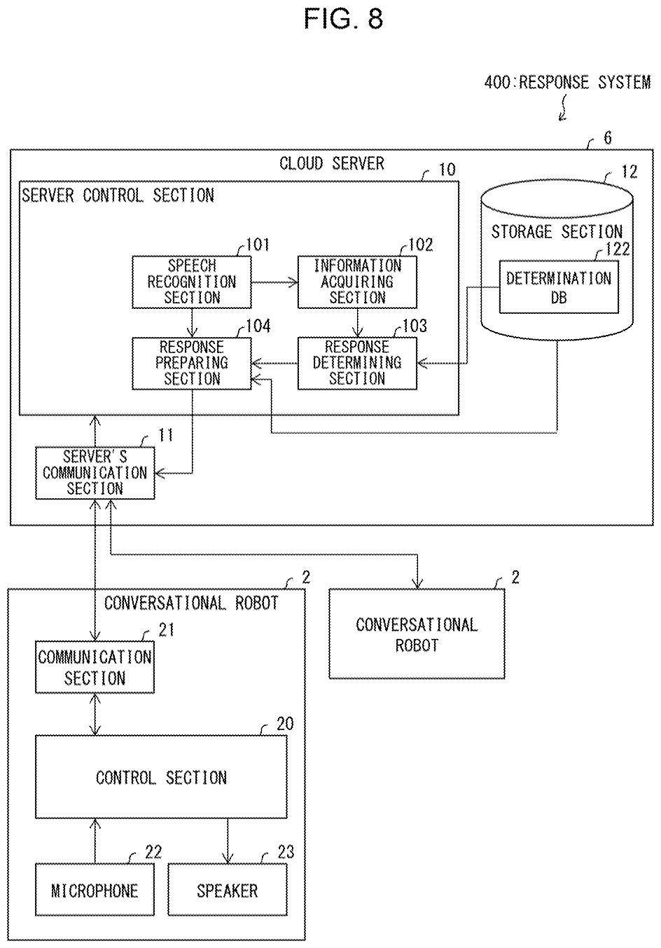

The following description will discuss Embodiment 4 in accordance with the present disclosure with reference to FIGS. 8 to 10. FIG. 8 is a block diagram illustrating configurations of main parts of conversational robots 2 and a cloud server 6 which are included in a response system 400 in accordance with Embodiment 4. The response system 400 includes one or more cloud servers 6 and one or more conversational robots 2. In the example shown in FIG. 8, the number of conversational robots 2 is two; however, the number of conversational robots 2 is not particularly limited, and may be, for example, one.

Each of the conversational robots 2 is a robot that converses with a user by responding to a speech of the user. The configuration of the conversational robots 2 is the same as that illustrated in FIG. 1. The conversational robots 2 may each be an apparatus that has the functions of the cloud server 6 (described below) and that is operable alone (operable without the cloud server 6).

The cloud server 6 determines whether or not to cause each conversational robot 2 to carry out a response. As illustrated in FIG. 8, the cloud server 6 includes a server control section (determining device) 10, a server's communication section 11, and a storage section 12.

The server's communication section 11 serves to communicate with the conversational robots 2. Note that, in cases where the cloud server 6 communicates with only one conversational robot 2 in the response system 400, it is not necessary that the server's communication section 11 receive robot identification information. On the contrary, in cases where there are two or more conversational robots 2 in the response system 400, the server control section 10 receives, from each of the conversational robots 2, not only a speech and a speech input time but also robot identification information.

The storage section 12 stores various kinds of data for use in the cloud server 6. Specifically, the storage section 12 at least stores a determination database (DB) 122. The storage section 12 also stores data for use in preparation of a response message (e.g., forms or templates for response messages).

(Determination DB)

The determination DB 122 is a database that is referenced to determine whether or not to prepare a response message and that stores one or more determination information items. As used herein, the “determination information” item refers to an information item in which (i) a time or a time period at or during which a speech input is to be carried out and (ii) a keyword that is indicative of at least part of a predictable result of speech recognition, are associated with each other.

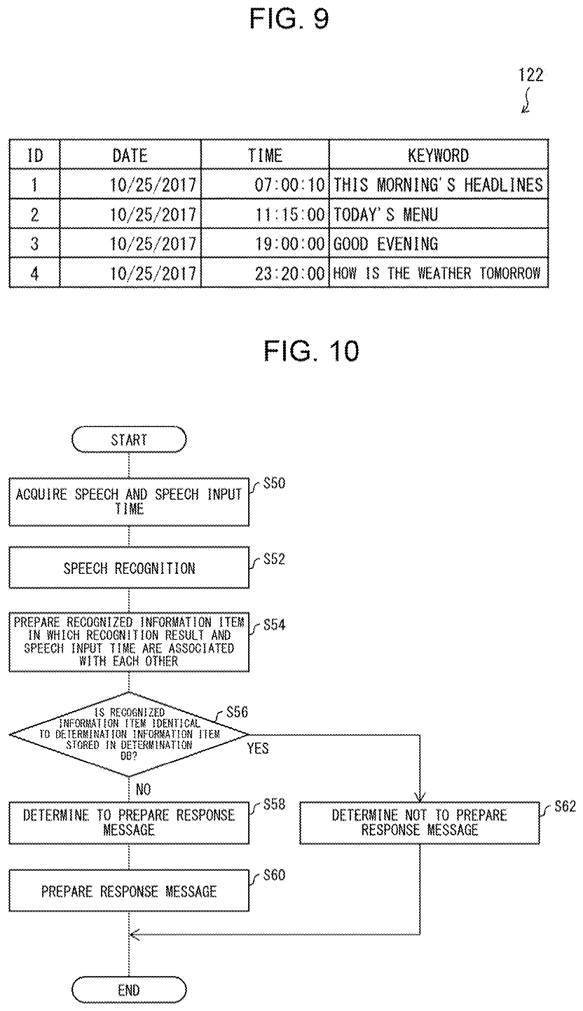

FIG. 9 illustrates one example of a data structure of the determination DB 122. In the example shown in FIG. 9, the determination DB 122 includes an “ID” column, a “DATE” column, a “TIME” column, and a “KEYWORD” column. Each record in FIG. 9 represents one determination information item. Note that the “DATE” column and “TIME” column may be integral with each other. Also note that the pieces of data in the “DATE” column and “TIME” column may indicate a time period from one time to another time, instead of indicating a point in time.

In the “ID” column, an identification code that uniquely identifies a determination information item is stored. In the determination DB 122, the data in the “ID” column is not essential. In the “DATE” column and “TIME” column, the month/date/year included in the time at which a speech input is to be carried out and the time included in the time at which the speech input is to be carried out are stored, respectively. In the “KEYWORD” column, a keyword that is indicative of at least part of a predictable result of speech recognition is stored.

Each record in the determination DB 122, that is, each determination information item, is prepared and pre-stored by the cloud server 6 or some other apparatus. The determination information item may be, for example, an information item indicative of a keyword that will possibly emanate at a certain point in time or during a certain time period from an audio broadcasting apparatus such as a TV set or a radio receiver present near a corresponding robot 2.

That is, it is preferable that a keyword that is stored in the “KEYWORD” column of the determination DB 122 is at least part of a speech that is scheduled to be uttered in a TV program, radio program, or the like, and preferable that the time (or time period) stored in the “DATE” column and “TIME” column is a time or a time period at or during which the speech is projected to be uttered in that program.

By employing such an arrangement in which the determination DB 122 stores, as a determination information item, (i) at least part of the speech that is scheduled to be uttered in a to-be-broadcast program or in a program that is being broadcast and (ii) when the speech is to be uttered, it is possible for the response determining section 103 (described later) to prevent a corresponding robot 2 from responding to that speech.

The server control section 10 serves to carry out an overall control of the cloud server 6. The server control section 10 includes a speech recognition section 101, an information acquiring section (recognized information acquiring section) 102, a response determining section 103, and a response preparing section 104. The speech recognition section 101 and the response preparing section 104 carry out processes similar to those carried out by the speech recognition section 101 and the response preparing section 104 illustrated in FIG. 1.

The information acquiring section 102 in accordance with Embodiment 4 sends, to the response determining section 103, a recognized information item acquired from the speech recognition section 101. The response determining section 103 in accordance with Embodiment 4 determines whether or not to prepare a response message (that is, whether or not to cause a corresponding conversational robot 2 to carry out a response), based on the recognized information item received from the information acquiring section 102. Specifically, the response determining section 103 refers to the determination DB 122 in the storage section 12 and determines whether the determination DB 122 contains a record indicative of (i) a time identical to the time (speech input time) contained in the recognized information item and (ii) a keyword identical to that of the result of speech recognition contained in the recognized information item. It should be noted that, if a determination information item is indicative of a time period instead of a time, the time period contained in the determination information item and a time contained in a recognized information item can be regarded as “identical”, provided that the time contained in the recognized information item falls within the time period contained in the determination information item.

If the determination DB 122 does not contain a record that is indicative of a time and keyword identical to those contained in the recognized information item, the response determining section 103 determines to prepare a response message. On the contrary, if the determination DB 122 contains a record that is indicative of a time and keyword identical to those contained in the recognized information item, the response determining section 103 determines not to prepare a response message. It should be noted that, in Embodiment 4, if the percentage of matching between a character string of a recognition result and a keyword in a determination information item is equal to or greater than a predetermined threshold, the two may be determined as “identical” to each other.

The response preparing section 104 prepares a response message, and sends the prepared response message to a corresponding conversational robot 2 via the server's communication section 11. In cases where robot identification information has been received from the conversational robot 2, the response preparing section 104 may send the response message to a conversational robot 2 that is indicated by the robot identification information associated with the recognition result. This makes it possible to send, back to a certain conversational robot 2, a response message that corresponds to a speech acquired at that conversational robot 2.

<<Flow of Process>>

Next, a flow of a response necessity determining process carried out by the response system 400 is described with reference to FIG. 10. FIG. 10 is a flowchart of a flow of the response necessity determining process carried out by the response system 400. The example shown in FIG. 10 also shows a flow of a response necessity determining process carried out in regard to a certain input speech (in regard to a single input), similarly to FIGS. 4 and 7.

The control section 20 of one of the conversational robots 2, upon receipt of an ambient sound (speech) via the microphone 22, acquires a speech input time. The control section 20 sends, to the cloud server 6, the input speech having the speech input time (and robot identification information) associated therewith. The server control section 10 of the cloud server 6 acquires the speech and the speech input time (and the robot identification information) (S50). The speech recognition section 101 carries out speech recognition of the acquired speech (S52), and prepares a recognized information item in which the recognition result and the speech input time are associated with each other (S54). The speech recognition section 101 sends the recognized information item to the information acquiring section 102.

Upon receipt of the recognized information item (recognized information acquiring step), the information acquiring section 102 sends the recognized information item to the response determining section 103. Upon receipt of the recognized information item, the response determining section 103 determines whether or not the received recognized information item is identical to any of the determination information item(s) in the determination DB 122 (S56, response determining step). Specifically, the response determining section 103 determines whether or not the determination DB 122 contains a record indicative of (i) a time identical to the speech input time indicated by the recognized information item (or a time period within which the speech input time falls) and (ii) a keyword identical to that of the result of speech recognition indicated by the recognized information item. If it is determined that the received recognized information item is identical to any of the determination information item(s) in the determination DB 122 (YES in S56), the response determining section 103 determines not to prepare a response message (S62). On the contrary, if it is determined that the received recognized information item is not identical to any of the determination information item(s) in the determination DB 122 (NO in S56), the response determining section 103 determines to prepare a response message (S58), and the response preparing section 104 prepares a response message that corresponds to the recognition result (S60). The response preparing section 104 sends the prepared response message to the conversational robot 2, and the conversational robot 2 outputs the response message via the speaker 23.

According to the above process, the response system 400 pre-stores, in the storage section, a determination information item(s) each of which contains (i) a time or a time period at or during which a speech input is to be carried out and (ii) a predictable result of speech recognition. With this arrangement, it is possible to prevent each conversational robot 2 from making a response if the time and the result of speech recognition, which are contained in a recognized information item prepared based on the speech inputted to the conversational robot 2, match the time or time period and keyword which are contained in any of the determination information item(s), respectively.

For example, in a case where the time when a keyword that should not be responded to is uttered is known in advance like in cases of TV or radio broadcasting, the keyword that should not be responded to and a time at which the keyword is projected to be uttered can be pre-stored as a determination information item in the storage section.

With this, the response system 400 is capable of preventing each robot 2 from outputting a response message at an inappropriate time. Thus, the response system 400 is capable of appropriately determining whether or not to respond to the audio from a TV set, radio receiver, or the like.

[Variations]

The foregoing embodiments each deal with an example in which an electronic apparatus that includes a control device is a conversational robot; however, the electronic apparatus included in the response system in accordance with each of the foregoing embodiments is not limited to the conversational robot, provided that the electronic apparatus has the conversational function. For example, the electronic apparatus(es) included in the response system may be an electrical appliance(s) such as computer equipment (e.g., a portable terminal(s) or a personal computer(s)), a speaker(s) alone, a microwave oven(s), or a refrigerator(s).

[Software Implementation Example]

Control blocks of the cloud server (1, 3), and the conversational robots (2, 4, 5) can be realized by a logic circuit (hardware) provided in an integrated circuit (IC chip) or the like or can be alternatively realized by software.

In the latter case, the cloud server (1, 3), and the conversational robots (2, 4, 5) each include a computer that executes instructions of a program that is software realizing the foregoing functions. The computer, for example, includes at least one processor (control device) and at least one computer-readable storage medium storing the program. The object of the present invention can be achieved by the processor of the computer reading and executing the program stored in the storage medium. The processor may be, for example, a CPU (Central Processing Unit). The storage medium may be “a non-transitory tangible medium” such as a ROM (Read Only Memory), a tape, a disk, a card, a semiconductor memory, and a programmable logic circuit. The computer may further include a RAM (Random Access Memory) or the like in which the program is loaded. Further, the program may be supplied to or made available to the computer via any transmission medium (such as a communication network and a broadcast wave) which enables transmission of the program. Note that one aspect of the present invention can also be implemented by the program in the form of a computer data signal embedded in a carrier wave which is embodied by electronic transmission.

[Recap]

A determining device (server control section 10 or control section 20) in accordance with Aspect 1 of the present invention is a determining device configured to determine whether or not to cause an electronic apparatus (conversational robot 2 or 4) that includes a speech input device (microphone 22) to respond, the determining device including: an information acquiring section (information acquiring section 102 or control section 20) configured to acquire a recognized information item in which a result of speech recognition of a speech inputted to the speech input device is associate with a speech input time or with a recognition time, the speech input time being a time at which the speech was inputted, the recognition time being a time at which the speech recognition was carried out; and a response determining section (response determining section 103 or response determining section 203) configured to determine whether or not to cause the electronic apparatus to carry out a response that corresponds to the recognized information item, the response determining section being configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

For example, in regard to sounds of TV shows or the like, the same sounds are outputted (from different television sets) at different places at the same time. According to the above arrangement, in a case where recognition results that are identical in content to each other are obtained at the same time, the determining device determines not to cause electronic apparatuses to carry out the responses that correspond to the recognized information items indicative of those recognition results. As such, the determining device is capable of preventing undesired responses that would result from audio from a TV set, radio receiver, or the like.

A determining device in accordance with Aspect 2 of the present invention may be arranged such that, in Aspect 1, the determining device further includes a speech recognition section (speech recognition section 101) configured to acquire the speech input time and the speech from each of a plurality of the electronic apparatuses and carry out the speech recognition of the speech, and prepare a plurality of the recognized information items in each of which the result of the speech recognition is associated with the speech input time or with the recognition time.

According to the above arrangement, the electronic apparatuses do not need to have the function of speech recognition and the function of preparing a recognized information item, provided that the electronic apparatuses are capable of acquiring a speech and sending the speech to the determining device. This allows the determining device to collect speeches from a greater number of kinds of electronic apparatus and determine whether or not to cause the electronic apparatuses to respond.

A determining device in accordance with Aspect 3 of the present invention may be arranged such that, in Aspect 1, the information acquiring section is configured to acquire the recognized information item from each of a plurality of the electronic apparatuses.

According to the above arrangement, the determining device itself does not need to carry out the speech recognition or determine the speech input time or the recognition time. As such, the processing load on the determining device can be reduced, and the speed of the determining process carried out by the response determining section can be improved.

A determining device in accordance with Aspect 4 of the present invention may be arranged such that, in any one of Aspects 1 to 3, the determining device further includes a response preparing section configured to prepare, based on a result of determination by the response determining section, a response message that corresponds to the recognized information item.

According to the above arrangement, in cases where the response determining section determines to cause an electronic apparatus to respond, it is possible to prepare a response message that corresponds to the recognized information item.

A determining device in accordance with Aspect 5 of the present invention may be arranged such that, in any one of Aspects 1 to 3, the recognized information item contains an identification information item that identifies which electronic apparatus has acquired the speech that has been subjected to the speech recognition, and that the determining device further includes a determination result sending section (response determining section 103) configured to send a result of determination by the response determining section to an electronic apparatus that corresponds to the identification information item contained in the recognized information item which has been subjected to the determination.

According to the above arrangement, the determining device itself does not need to determine the details of a control regarding a response, such as a response message, response action, or the like. This makes it possible to reduce the processing load on the determining device. Furthermore, according to the above arrangement, the determining device needs only send the result of determination of response necessity to an electronic apparatus. As such, it is possible to reduce the volume of transmitted data and to thereby reduce the load related to communications, as compared to when the determining device determines how to respond and sends, to the electronic apparatus, information indicative of how to respond. Thus, according to the above arrangement, it is possible to improve the speed of each process carried out by the determining device.

A determining device in accordance with Aspect 6 of the present invention may be arranged such that, in any one of Aspects 1 to 5, the determining device further includes a recognized information storing section (information acquiring section 102) configured to store, in a storage section, the recognized information item which has been acquired by the information acquiring section, the response determining section being configured to determine, at a prescribed point in time, in regard to each of a plurality of the recognized information items stored in the storage section, whether or not to prepare a response that corresponds to each of the plurality of recognized information items.

According to the above arrangement, for example, in a case where speeches (or recognized information items) are received substantially at the same time from a plurality of electronic apparatuses, it is possible to successively carry out determinations on the speeches (or recognized information items) at prescribed points in time.

In regard to sounds of TV shows or the like, the same sounds are outputted at different places at the same time. It is inferred that, in such cases, a plurality of electronic apparatuses acquire the sounds substantially concurrently and send them to the determining device. According to the above arrangement, it is possible to accurately carry out the determination even in such cases.

A determining device in accordance with Aspect 7 of the present invention may be arranged such that, in any one of Aspects 1 to 6, the response determining section is configured to refer to a determination information item which is pre-stored in a storage section and in which (i) a time or a time period at or during which a speech input is to be carried out and (ii) a keyword that is indicative of at least part of a predictable result of speech recognition are associated with each other, and determine not to prepare the response that corresponds to the recognized information item if the speech input time or the recognition time and the result of the speech recognition which are contained in the recognized information item match the time or the time period and the predictable result of speech recognition which are contained in the determination information item, respectively.

According to the above arrangement, (i) a time or a time period at or during which a speech input is to be carried out and (ii) a predictable result of speech recognition are pre-stored as a determination information item, and thereby it is possible, if the recognized information item from the speech input device matches the time or time period and the result of speech recognition, to cause the electronic apparatus not to respond.

For example, in a case where the time when a keyword that should not be responded to is uttered is known in advance like in cases of TV or radio broadcasting, the keyword that should not be responded to and a time at which the keyword is projected to be uttered can be pre-stored as a determination information item in the storage section. With this, the determining device is capable of preventing an electronic apparatus from outputting a response message at an inappropriate time. Thus, the above arrangement is capable of appropriately determining whether or not to respond to the audio from a TV set, radio receiver, or the like.

An electronic apparatus (conversational robot 2 or 4) in accordance with Aspect 8 of the present invention is an electronic apparatus including a speech input device (microphone 22), the electronic apparatus further including a responding section configured to carry out a response in accordance with a result of determination by the determining device recited in Aspect 1.

A response system (response system 100, 200, 300, 400) in accordance with Aspect 9 of the present invention is a response system including: a determining device recited in any one of Aspects 1 to 7; and an electronic apparatus recited in Aspect 8.

A method of controlling a determining device (server control section 10 or control section 20) in accordance with Aspect 10 of the present invention is a method of controlling a determining device that is configured to determine whether or not to cause an electronic apparatus (conversational robot 2 or 4) that includes a speech input device (microphone 22) to respond, the method including: an information acquiring step including acquiring a recognized information item in which a result of speech recognition of a speech inputted to the speech input device is associated with a speech input time or with a recognition time, the speech input time being a time at which the speech was inputted, the recognition time being a time at which the speech recognition was carried out; and a response determining step including determining whether or not to cause the electronic apparatus to carry out a response that corresponds to the recognized information item, the response determining step including determining not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

The arrangement in accordance with any one of Aspects 8 to 10 brings about similar effects to those provided by the determining device recited in Aspect 1.

The determining device according to the foregoing embodiments of the present invention may be realized by a computer. In this case, the present invention encompasses: a control program for the determining device which program causes a computer to operate as the foregoing sections (software elements) of the determining device so that the determining device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100, 200, 300, 400 response system
1, 3, 6 cloud server
2, 4, 5 conversational robot
10 server control section (determining device)
101 speech recognition section
102 information acquiring section (recognized information storing section)
103 response determining section (determination result sending section)
104 response preparing section
11 server's communication section
12, 24 storage section
121, 122 determination DB
20 control section (determining device)
201 speech recognition section
202 response preparing section
203 response determining section
21 communication section
22 microphone (speech input device)
23 speaker

1. A determining device configured to determine whether or not to cause an electronic apparatus that includes a speech input device to respond, the determining device comprising:
an information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining section configured to determine whether or not to cause the electronic apparatus to carry out a response that corresponds to the recognized information item,
the response determining section being configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

2. The determining device according to claim 1, further comprising a speech recognition section configured to
acquire the speech input time and the speech from each of a plurality of the electronic apparatuses and carry out the speech recognition of the speech, and
prepare a plurality of the recognized information items in each of which the result of the speech recognition is associated with the speech input time or with the recognition time.

3. The determining device according to claim 1, wherein the information acquiring section is configured to acquire the recognized information item from each of a plurality of the electronic apparatuses.

4. The determining device according to claim 1, further comprising a response preparing section configured to prepare, based on a result of determination by the response determining section, a response message that corresponds to the recognized information item.

5. The determining device according to claim 1, wherein the recognized information item contains an identification information item that identifies which electronic apparatus has acquired the speech that has been subjected to the speech recognition,
the determining device further comprising a determination result sending section configured to send a result of determination by the response determining section to an electronic apparatus that corresponds to the identification information item contained in the recognized information item which has been subjected to the determination.

6. The determining device according to claim 1, further comprising a recognized information storing section configured to store, in a storage section, the recognized information item which has been acquired by the information acquiring section,
the response determining section being configured to determine, at a prescribed point in time, in regard to each of a plurality of the recognized information items stored in the storage section, whether or not to prepare a response that corresponds to each of the plurality of recognized information items.

7. The determining device according to claim 1, wherein the response determining section is configured to
refer to a determination information item which is pre-stored in a storage section and in which (i) a time or a time period at or during which a speech input is to be carried out and (ii) a keyword that is indicative of at least part of a predictable result of speech recognition are associated with each other, and
determine not to prepare the response that corresponds to the recognized information item if the speech input time or the recognition time and the result of the speech recognition which are contained in the recognized information item match the time or the time period and the predictable result of speech recognition which are contained in the determination information item, respectively.

8. An electronic apparatus comprising a speech input device,
the electronic apparatus further comprising a responding section configured to carry out a response in accordance with a result of determination by the determining device recited in claim 1.

9. A response system comprising:
a determining device configured to determine whether or not to cause an electronic apparatus that includes a speech input device to respond, the determining device comprising:
an information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining section configured to determine whether or not to cause the electronic apparatus to carry out a response that corresponds to the recognized information item,
the response determining section being configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item; and
the electronic apparatus further comprising a responding section configured to carry out a response in accordance with a result of determination by the determining device.

10. A method of controlling a determining device that is configured to determine whether or not to cause an electronic apparatus that includes a speech input device to respond, the method comprising:
an information acquiring step comprising acquiring a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining step comprising determining whether or not to cause the electronic apparatus to carry out a response that corresponds to the recognized information item,
the response determining step comprising determining not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

11. A non-transitory computer-readable storage medium storing therein a control program for causing a computer to function as a determining device recited in claim 1, the control program being a program for causing the computer to function as the information acquiring section and the response determining section.
